(19) United States
(12) Patent Application Publication
(10) Pub. No.: US 2026/0135712 A1
(43) Pub. Date: May 14, 2026

(54) SYSTEM AND METHOD FOR GENERATING A UNIQUE SIGNATURE OF A DATA ITEM OF AN ENTERPRISE

(71) Applicant: Honeywell International Inc., Charlotte, NC (US)

(72) Inventors: Arnab Bhattacharjee, Bangalore (IN); Srikant Srinivasan, Bangalore (IN); Nikhil Bansal, Bangalore (IN); Dipanjan Saha, Bangalore (IN)

(21) Appl. No.: 18/943,941

(22) Filed: Nov. 12, 2024

(51) Int. Cl. H04L 9/32

(52) U.S. Cl. CPC H04L 9/3247

(57) ABSTRACT

The present disclosure relates to a method for generating a unique signature of a data item of an enterprise. The method comprises identifying for the data item, a source data system, a target data system, and an associated data channel, where the source data system and the target data system belong to a plurality of data systems of the enterprise, and the associated data channel belongs to a plurality of data channels of the enterprise. The method further comprises accessing a system inventory of the enterprise, comprising details of the plurality of data systems of the enterprise, for retrieving a first set of information having a unique reference of the source data system of the data item. The method further comprises accessing a channel inventory of the enterprise, comprising details of the plurality of data channels of the enterprise, for retrieving a second set of information having a channel name, the unique reference of the source data system, and a unique reference of the target data system. The method further comprises generating the unique signature of the data item based on processing of the first set of information and the second set of information, and storing the unique signature of the data item in a database.

### TECHNICAL FIELD

The present disclosure relates to a system and method for generating unique signatures of a data item, and particularly, relates to generation of unique signatures of data items of an enterprise in an industrial environment.

### BACKGROUND

Enterprises is industrial environments generally comprises a plurality of industrial plants at one or more locations. Each industrial plant of an enterprise may comprise a plurality of assets and sensor devices performing different operations essential to the functioning of the industrial plant. The assets of an industrial plant include machinery and equipment used for performing the basic and essential operations of the industrial plant. Further, the sensor devices of an industrial plant are used for generating alerts and data items relating to operations of such machinery or equipment. For instance, in a chemical plant having a boiler, sensor devices connected to the boiler may include sensors for detecting temperature and pressure within the boiler, and data items generated by such sensors may include data points, tags, and limits associated with the temperature and pressure detected.

Due to the vast nature of operations within an industrial plant, and the need of ensuring that every asset and device of the industrial plant is functioning correctly, industrial plants often use data management systems or networks for controlling the operations of the industrial plants. A data management system of an industrial plant has one or more data systems for processing data generated by assets and sensor devices of the industrial plant, and are used for managing operations of the assets. The data systems generally used in data management systems of the industrial plants include Distributed Control Systems (DSCs) and Process History Databases (PHDs). The data systems of an industrial plant are generally established over one or more levels of the data management system of the industrial plant, where each level, having one or more data systems, is responsible for performing a specific operation, functionality, or purpose of the data management system. For example, the functionalities performed by each level of a data management system of an industrial plant may include receiving data items such as parameters from sensor devices, providing instructions to data system in lower levels regarding corrective actions to be taken to resolve an alert generated etc.

Most data management systems used in industrial plants of an enterprise have 4 or 5 levels. Each level of a data management system comprises either assets, sensor devices, or one or more data systems. For most industrial plants, lower levels of data management systems include a level 0 comprising assets such as machinery and equipment of the industrial plants, a level 1 comprising sensor devices connected to assets of the first level, a level 2 comprising data systems for processing of parameters retrieved from sensor devices of level 1 and controlling operations of assets of the industrial plants, and a level 3 comprising data systems for managing and synchronizing operations of two or more data systems of level 2. Generally, data items may be first generated at level 2 corresponding to processing of parameters obtained from the sensor devices of level 1. Higher levels of data management systems of industrial plants may consist of one or more levels for internet-based communication with external systems like observer system of the enterprise, where at least one level of the higher levels is dedicated for establishing security measures such as firewalls.

In most data management systems of industrial plants, data items generated at a data system of a specific level may be copied or transferred from one or more data systems of an adjacent level. Transfer of parameters or data items between the data system in different levels of an industrial plant is based on data channels established between the different data systems. For data systems in the lower levels of data management system of an industrial plant, the data channels connecting the data systems may be physical data channel. Data systems in higher levels of data management may be connected by internet-based data channels for communication with external systems or entities associated with an industrial plant. The data channels of an industrial plant are used for the transfer of data items between data systems at different levels of the data management system of a plant.

For a data item transferred from one data system to another data system, the data system from which the data item originated is hereafter referred to as a source data system of the data item and the data system to which the data item is transferred is hereafter referred to as a target data system of the data item. A data channel used for transfer of the data item from the source data system to the target data system is hereafter referred to as an associated data channel of the data item. The data item transferred to the target data system may be assigned the same or different name or tag by the target data system. Hence, there may exist a plurality of copies of a data item at different data systems at different levels of the industrial plant.

At an enterprise level, the operations of one or more industrial plants of the enterprise may be managed by an observer system of the enterprise, where the observer system refers to a processing system or unit used by one or more authorized individuals of the enterprise for providing control instructions to the industrial plants for resolution of an error, alert or KPI (Key Performance Indicator) arising from the industrial plants. In many instances, the observer system of an enterprise may be a cloud-based system to which the data management systems of multiple industrial plants of the enterprise may be connected, and the control instructions may be generated by the observer system by processing of data items ingested from data management systems of one or more industrial plants of the enterprise.

When data items from one or more industrial plants of an enterprise are uploaded to or ingested by an observer system of the enterprise, there may exist several data items having the same name, tag, or identifier. The observer system may be unable to provide relevant and effective control instructions or insights in instances where a source data system of a data item associated with an error cannot be identified due to existence of multiple copies of the data item with same name at different data systems of the industrial plant. Such complexity arising due to name collisions also occur in instances where two or more industrial plants have the same data management system which follow the same naming convention, leading to circumstances where data items from two or more items may have the same name, tag, or identifier, thereby making it difficult for the observer system to identify the source data system of a data item.

Particularly, for observer systems implemented as a cloud-based system, the observer system has no context or information regarding the data management systems of different industrial plants, and thereby no knowledge regarding data systems that may possibly be the source of the data item. Hence, in instances where name collision of data items occurs, a cloud-based observer system is unable to identify a source system of each data item. Thus, an accurate identification of a source data system of the data item is difficult for an observer system.

In such instance, the observer system may not have sufficient context as to the origin of a specific data item identified to be associated with an error to be resolved, and generating corrective actions may be difficult in such cases. Such a complexity also arises when two or more industrial plants of the enterprise have the same network of assets, sensor devices, and data systems within the data management systems, leading to similar data items with same names or tags being generated from the two or more industrial plants. Such an instance of generation of copied of a data item by two or more industrial plants of an enterprise occurs when the infrastructure of one industrial plant, along with a data management system of the industrial plant, is adopted or implemented by other industrial plants of the enterprise.

Hence, there is a requirement for a mechanism of onboarding or ingesting data items from the different levels of data management systems of industrial plants of an enterprise such that the observer system or a similar enterprise-level system used for managing operations of the enterprise has context or information regarding the source of each data item. Further, there arises a need for ingesting the data items in a manner so as to avoid name collisions of data items.

### SUMMARY OF THE INVENTION

In general, embodiments of the present disclosure herein provide a system and method for generating unique signatures of data items of an enterprise. Other implementations will be, or will become, apparent to one with skill in the art upon examination of the following figures and detailed description. It is intended that all such additional implementations be included within this description be within the scope of the disclosure and be protected within the scope of the following claims.

In accordance with an embodiment of the present disclosure, a method of generating unique signature of a data item of an enterprise is described. The method comprises identifying for the data item, a source data system, a target data system, and an associated data channel, where the source data system and the target data system belong to a plurality of data systems of the enterprise, and the associated data channel belongs to a plurality of data channels of the enterprise. The method further comprises accessing a system inventory of the enterprise, where the system inventory comprises details of each data system of the plurality of data systems of the enterprise. A first set of information is retrieved from the system inventory, such the first set of information comprises a unique reference of the source data system of the data item.

The method further comprises accessing a channel inventory of the enterprise, where the channel inventory comprises details of each data channel of the plurality of data channels of the enterprise. The details of each data channel are stored such that the channel inventory has reference to the plurality of data systems of the enterprise. A second set of information is retrieved from the channel inventory, such that the second set of information comprises a channel name, the unique reference of the source data system, and a unique reference of the target data system. The method further comprises generating the unique signature of the data item based on processing of the first set of information and the second set of information, and storing the unique signature of the data item in a database.

In another embodiment of the present invention, an exemplary system for generating a unique signature for a data item of an enterprise is provided. The system comprises a processor and a memory coupled with the processor, wherein the memory stores program instructions configured to identify for the data item, a source data system, a target data system, and an associated data channel, where the source data system and the target data system belong to a plurality of data systems of the enterprise, and the associated data channel belongs to a plurality of data channels of the enterprise. Further, the program instructions are also configured to access a system inventory of the enterprise, where the system inventory comprises details of each data system of the plurality of data systems of the enterprise. A first set of information is retrieved from the system inventory, such the first set of information comprises a unique reference of the source data system of the data item.

Further, the program instructions are also configured to access a channel inventory of the enterprise, where the channel inventory comprises details of each data channel of the plurality of data channels of the enterprise. The details of each data channel are stored such that the channel inventory has reference to the plurality of data systems of the enterprise. A second set of information is retrieved from the channel inventory, such that the second set of information comprises a channel name, the unique reference of the source data system, and a unique reference of the target data system. The program instructions are also configured to generate the unique signature of the data item based on processing of the first set of information and the second set of information, and to store the unique signature of the data item in a database.

In yet another embodiment of the present invention, a non-transitory computer-readable storage medium is provided comprising computer program code for execution by one or more processors of an apparatus, the computer program code configured to, when executed by the one or more processors, cause the apparatus to identify for the data item, a source data system, a target data system, and an associated data channel, where the source data system and the target data system belong to a plurality of data systems of the enterprise, and the associated data channel belongs to a plurality of data channels of the enterprise. The computer program code is also configured to access a system inventory of the enterprise, where the system inventory comprises details of each data system of the plurality of data systems of the enterprise. A first set of information is retrieved from the system inventory, such the first set of information comprises a unique reference of the source data system of the data item.

Further, the computer program code is also configured to access a channel inventory of the enterprise, where the channel inventory comprises details of each data channel of the plurality of data channels of the enterprise. The details of each data channel are stored such that the channel inventory has reference to the plurality of data systems of the enterprise. A second set of information is retrieved from the channel inventory, such that the second set of information comprises a channel name, the unique reference of the source data system, and a unique reference of the target data system. The computer program code is also configured to generate the unique signature of the data item based on processing of the first set of information and the second set of information, and to store the unique signature of the data item in a database.

### BRIEF DESCRIPTION OF THE DRAWINGS

The accompanying drawings constitute a part of the description and are used to provide further understanding of the present disclosure. Such accompanying drawings illustrate the embodiments of the present disclosure which are used to describe the principles of the present disclosure. The embodiments are illustrated by way of example and not by way of limitation in the figures of the accompanying drawings in which like references indicate similar elements. It should be noted that references to “an” or “one” embodiment in this disclosure are not necessarily to the same embodiment, and they mean at least one. In the drawings:

FIG. 1 illustrates a system for generating unique signature of data item of an industrial plant, in accordance with an embodiment of the present invention;

FIG. 2 illustrates steps executed by a method for generating unique signatures of data items of an enterprise, in accordance with an embodiment of the present invention.

FIG. 3 illustrates configuration of the proposed system with respect to a data management system of an industrial plant of an enterprise and an observer system of the enterprise.

FIG. 4 illustrates configuration of the proposed system with respect to a plurality of data management systems of an enterprise and an observer system of the enterprise.

FIG. 5 illustrates an inventory module for populating a system inventory and a channel inventory of an enterprise corresponding to inputs provided for multiple industrial plants, in accordance with an embodiment of the present invention.

FIG. 6 illustrates steps executed by an inventory module for populating a system inventory and a channel inventory of an enterprise, in accordance with an embodiment of the present invention.

FIG. 7 illustrates a unique signature generation module for generating unique signatures of data items based on information stored in an inventory database, in accordance with an embodiment of the present invention.

FIG. 8 illustrates steps executed by a unique signature generation module for generating unique signatures for data items to be uploaded to an observer system, in accordance with an embodiment of the present invention.

FIG. 9 illustrates an implementation of the proposed system for generating unique signatures of data items of an enterprise based on queries raised by a user, in accordance with an embodiment of the present invention.

FIG. 10 illustrates an observer system having modules for retrieval and processing of unique signature of data items of an enterprise, in accordance with an embodiment of the present invention.

FIG. 11 illustrates steps executed by the observer system for retrieval and processing of unique signature of data items of an enterprise, in accordance with an embodiment of the present invention.

### DETAILED DESCRIPTION OF THE INVENTION

The description that follows describes, illustrates and exemplifies one or more particular embodiments of the invention in accordance with its principles. This description is not provided to limit the invention to the embodiments described herein, but rather to explain and teach the principles of the invention in such a way that enables one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labelled with the same reference numerals. However, sometimes these elements may be labelled with differing numerals, such as, for example, in cases where such labelling facilitates a clearer description. Additionally, the drawings set forth herein are not necessarily drawn to scale, and in some instances, proportions may have been exaggerated to more clearly depict certain features. Such labelling and drawing practices do not necessarily implicate an underlying substantive purpose. As stated above, the specification is intended to be taken as a whole and interpreted in accordance with the principles of the invention as taught herein and understood to one of ordinary skill in the art.

With respect to the exemplary systems, components and architecture described and illustrated herein, it should also be understood that the embodiments may be embodied by, or employed in, numerous configurations and components, including one or more systems, hardware, software, or firmware configurations or components, or any combination thereof, as understood by one of ordinary skill in the art. Accordingly, while the drawings illustrate exemplary systems including components for one or more of the embodiments contemplated herein, it should be understood that with respect to each embodiment, one or more components may not be present or necessary in the system.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

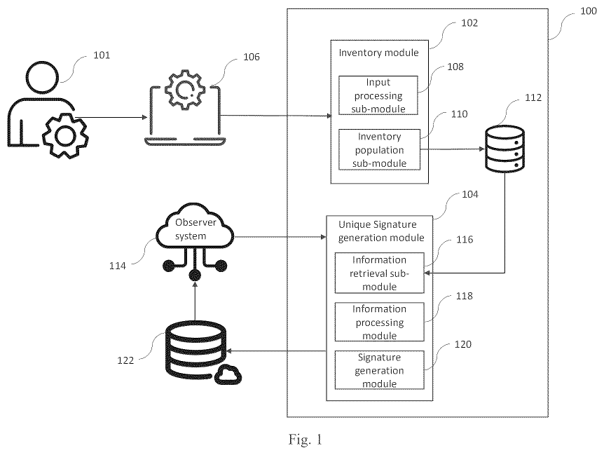

The present disclosure relates to a system and method for generating unique signatures of data items of an enterprise. The system generates a unique signature for each data item of an industrial plant of an enterprise based on data relating to a source data system and an associated data channel of the data item. FIG. 1 illustrates the system for generating unique signature of data item of an industrial plant, in accordance with an embodiment of the present invention. The proposed system 100 has an inventory module 102 and a unique signature module 104. The inventory module 102 is used for generating a system inventory and a channel inventory of the enterprise. Information relating to a set of data systems and a set of data channels of an industrial plant of the enterprise are entered into the system inventory and channel inventory of the enterprise using the inventory module 102, where the information is provided as input by an authorized individual 101 of the industrial plant. The authorized individual 101 may be any individual of the industrial plant having sufficient authorization and knowledge regarding the set of data systems of the industrial plant, the set of data channels between the set of data systems, and the operations of the assets and data systems of the industrial plant.

The authorized individual 101 may provide such information to the inventory module 102 by means of an input device 106. The input device 106 may be a PC, tablet, smartphone, or any similar device used for providing inputs. The information relating to the set of data systems, provided by the authorized individual 101, may comprise for each data system of the industrial plant, a name of the industrial plant, an identifier of the location of the industrial plant, a name of the data system, and a unique reference of the data system. The unique reference of the data system is a unique name or identifier assigned to the data item by the authorized individual 101, and is a mandatory field to be provided by the authorized individual 101. The unique reference of each data system of the industrial plant may be assigned is such a manner that the unique reference would give sufficient context regarding the data system. The information relating to the data systems may be provided in different formats such as spreadsheets, XML (Extensible Markup Language), and JSON (JavaScript Object Notation) files.

The information relating to the set of data channels, provided by the authorized individual 101, relates primarily to details of source data systems and target data systems of the data channels. The information relating to the set of data channels, provided by the authorized individual 101, may comprise for each data channel of the industrial plant, a name of the data channel, a description of the data channel, an identifier of the location of the data channel, a unique reference of a source data system of the data channel, a description of type of the source data system, level of the data management system of the industrial plant at which the source data system of the data channel is located, a unique reference of a target data system of the data channel, a description of type of the target data system, and level of the data management system of the industrial plant at which the target data system of the data channel is located.

The information relating to the set of data systems and the set of data channels of an industrial plant provided by the authorized individual 101 is retrieved by an input processing sub-module 108 of the inventory module 102. In certain embodiments, the information provided by the authorized individual 101 may be stored in a database of the industrial plant. In other embodiments, the information may be stored in a cloud-based database accessible to an observer system of the enterprise. The input processing sub-module 108 of the inventory module 102 retrieves the information relating to the set of data systems and set of data channels of the industrial plant directly from the authorized individual 101 or from a database at which the information is stored. The information retrieved by the input processing sub-module 108 is thereafter processed to extract specific parameters to be included in the system inventory and the channel inventory of the enterprise.

The processing performed by the input processing sub-module 108 may include conversion of the retrieved information into a format suitable for extraction of the specific parameters, extraction of the parameters from the converted information, or conversion of any one of the specific parameters into an appropriate format. The parameters obtained after the processing by the input processing sub-module 108 is thereafter used by an inventory population sub-module 110 of the inventory module 102. The inventory population sub-module 110 compiles and stores the parameters obtained from the input processing sub-module 108 into the system inventory and the channel inventory maintained in an inventory database 112. The parameters stored in the system inventory for each data system includes at least a unique reference of the data system. Table. 1 illustrates fields of an exemplary system inventory comprising parameters of one data system of an industrial plant. In the example cited in Table 1, MnR_BLR02_CDU1 is a unique reference of a data system assigned by an authorized individual of the industrial plant.

TABLE 1

| # | Details | Example |
|---|---|---|
| 1 | tenant_name | xyz_corporation |
| 2 | location_identifier | bangalore |
| 3 | system_name | MnR |
| 4 | Source_system_Unique_ref | MnR_BLR02_CDU1 |

The parameters stored in the channel inventory for each data channel includes at least a unique reference of a source data system and a unique reference of a target data system of the industrial plant. Table. 2 illustrates fields of an exemplary channel inventory comprising parameters of one data channel of a set of data systems of an industrial plant. In the example cited in Table 2, L2EXPR500 is a unique reference of a source data system and L3ACM1 is a unique reference of a target data system of the data channel, assigned by an authorized individual of the industrial plant.

TABLE 2

| Details | Example |
|---|---|
| Channel Name | Malibu |
| Channel Description | ACM connection to Experion |
| | R500 |
| Location Identifier | Mumbai |
| Source System Unique | L2EXPR500 |
| Ref | |
| Source System Type | Control System |
| Source System | Refinery Experion System |
| Description | |
| Source Network Level | L2 |
| Target System Unique | L3ACM1 |
| Ref | |
| Target System Type | Alarm System |
| Target System | ACM Master Alarm System |
| Description | |
| Target Network Level | L3 |

The system inventory and channel inventory are generated by the inventory module 102 in such a manner that entries have been made in the system inventory corresponding to each source data system and each target data system referenced in the channel inventory. Further, the unique reference of a source data system and the unique reference of a target data system is the same as the unique reference provided in the entries in the system inventory corresponding to the source data system and the target data system.

The inventory module 102 may be used by a plurality of authorized individuals for creating entries in the system inventory and channel inventory for all industrial plants of the enterprise, where each authorized individual provides information relating to data systems and data channel of a single industrial plant of the enterprise. The system inventory and the channel inventory created and stored in an inventory database 112 by the inventory module 102 may be used by an observer system 114 of an enterprise for obtaining further information relating to the data systems and data channels of one or more industrial plants of the enterprise. The system inventory and channel inventory of the enterprise is created prior to generation of unique signatures of data items of the enterprise. In certain embodiments, the inventory module 102 may also be used for updating the system inventory and channel inventory of the enterprise to reflect changes made to the data management systems of one or more industrial plants of the enterprise. In certain embodiments of the present invention, separate system inventories and channel inventories may be created for each industrial plant of an enterprise, where the system inventories and channel inventories may be stored in a same database or in different databases.

The unique signature generation module 104 is used for generating a unique signature for each data item of the enterprise prior to uploading of the data items to the observer system 114 based on information retrieved from the inventory database 112. For generating the unique signature of each data item to be uploaded to the observer system 114, the entries of the system inventory and channel inventory corresponding to the data item may be accessed by the unique signature generation module 104 from the inventory database 112, where the information retrieved from the system inventory and the channel inventory relate to a source data system and an associated data channel of the data item respectively.

An information retrieval sub-module is used for determining data items corresponding to which information from the system inventory and channel inventory are to be retrieved. The determination of the data items may be obtained based on processing of a query provided by the observer system 114. The query may be provided by the observer system 114 corresponding to detection of an error, warning, or KPI deviation relating to operations of one or more industrial plants of the enterprise. The query may indicate the industrial plants for which data items are to be analyzed for resolution of the error. Alternatively, the query may be a list of data items to be ingested, where the data items may belong to one or more industrial plants of the enterprise. Further still, the query may also indicate a type of data item to be analyzed or processed by the observer system 114. For example, the observer system 114 may be required to identify corrective actions for an error relating to functioning of boilers in industrial plants of the enterprise, and the query provided by the observer system may relate to retrieval of data items associated with temperature and pressure within the boilers.

The information retrieval sub-module 116 may thus process such queries to identify the data items, and retrieve for each data item a first set of information relating to source data system of the data item, hereafter referred to as source system information, and a second set of information relating to associated data channel of the data item, hereafter referred to as associated data channel information. The source system information is retrieved from the entries of the system inventory corresponding to the data item stored in the inventory database 112. Similarly, the associated data channel information is retrieved from the entries of the channel inventory corresponding to the data item stored in the inventory database 112.

The source system information and the associated data channel information retrieved by the information retrieval sub-module 116 is used by an information processing sub-module 118 of the unique signature generation module 104 to extract specific fields to be included in the unique signature of the data item. The specific fields may be extracted from the source system information and the associated data channel information based on a pre-determined set of rules provided by an individual of the enterprise based on the nature or characteristics required for the unique signatures of data items uploaded to the observer system 114.

In a first set of specific fields extracted from the source system information, relating to the source data system of the data item, one requisite or mandatory field is the unique reference of the source data system. The first set of specific fields may be extracted based on rules defined by an individual of the enterprise, where the rules may specify the types of fields required corresponding to a type of the data item and characteristics of data system corresponding to which the source system information is obtained. The rules defined by the individual of the enterprise may also include a list of parameters included in the source system information that are to be excluded in the first set of specific fields.

In certain embodiments of the present invention, one or more fields may be extracted based on modifications made to one or more parameters included in the source system information. In another embodiment, one or more fields extracted corresponding to the first set of specific fields may be obtained by combining one or more parameters include in the source system information. In another embodiment, one or more fields of the first set of specific fields may be obtained based on conversion of format of one or more parameters included in the source system information.

In one embodiment, the first set of specific fields may also include type of the data item and an identifier of the data item. Herein, type of a data item may indicate values like tag, asset, or limit and identifier of a data item may be a candidate key from the system inventory that can uniquely identify a row in the system inventory. In another embodiment of the present invention, the first set of specific fields may include all parameters listed in the source system information.

In a second set of specific fields extracted from the associated data channel information, relating to the associated data channel of the data item, requisite or mandatory fields include unique reference of the source data system, unique reference of the target data system, and name of the associated data channel. The second set of specific fields may be extracted based on rules defined by an individual of the enterprise, where the rules may specify the types of fields required corresponding to characteristics of the associated data channel corresponding to which the associated data channel information is obtained. The rules defined by the individual of the enterprise may also include a list of parameters included in the associated data channel information that are to be excluded in the second set of specific fields.

In certain embodiments of the present invention, one or more fields may be extracted based on modifications made to one or more parameters included in the associated data channel information. In another embodiment, one or more fields extracted corresponding to the second set of specific fields may be obtained by combining one or more parameters include in the associated data channel information. In another embodiment, one or more fields of the first set of specific fields may be obtained based on conversion of format of one or more parameters included in the associated data channel information.

In one embodiment, the second set of specific fields may also include an identifier of location of the associated data channel, a type of the source data system, and a type of the target data system. In another embodiment of the present invention, the second set of specific fields may include all parameters listed in the associated data channel information.

The specific fields extracted from source system information and the associated data channel information relating to a data item is used by a signature generation sub-module 120 of the unique signature generation module 104 to generate a unique system identifier and a unique channel identifier of the data item. The unique system identifier is generated by processing the first set of specific fields extracted from the source system information relating to the source data system of the data item. In some embodiments, the processing performed for generating the unique system identifier may include a compilation of the first set of specific fields in a format pre-determined by an individual of the enterprise based on requirements of the observer system 114. For example, the format used for generating unique system identifier may be as follows:

Source_system_Unique_ref <\hat{ }_\hat{ }>data item_type<\hat{ }_\hat{ }>data item_identifier

In the above-mentioned format, “Source_system_Unique_ref”, “data item_type”, and “data item_identifier” relates to unique reference of the source system of the data item, type of the data item, and identifier of the data item respectively. In other embodiments, processing performed for generating a unique system identifier of a data item may include tokenization, feature selection, data cleansing etc.

Similarly, the unique channel identifier of a data item may be generated by the signature generation sub-module 120 by processing the second set of specific fields extracted from the associated data channel information relating to the associated data channel of the data item. In some embodiments, the processing performed for generating the unique channel identifier may include a compilation of the second set of specific fields in a format pre-determined by an individual of the enterprise based on requirements of the observer system 114. In other embodiments, processing performed for generating a unique system identifier of a data item may include tokenization, feature selection, data cleansing etc.

The unique system identifier and the unique channel identifier generated for a data item may be utilized for generating a unique signature of the data item. The unique signature thus generated by the signature generation sub-module 120 is indicative of the source data system and associated data channel of the data item, and may be used for accurately identifying the source of the data item. The signature generation sub-module 120 generates unique signatures in such a manner for all data items to be uploaded to the observer system 114. The unique signatures generated for the data items may be stored in a signature database 122. The observer system 114, after ingesting the data items, may access the signature database 122 to retrieved the unique signatures of the data items in order to identify the source data system and the associated data channel of each data item. In addition to aiding the identification of the source data system of a data item, the unique signatures may also be used to track the lineage of the data item. Further, the unique signatures help in avoiding name collision of data items of one or more industrial plants. In certain embodiments where information relating to data channels is not utilized, or not provided by an authorized individual, the unique signatures of data items are generated based on the unique system identifiers created corresponding to source data systems of the data items.

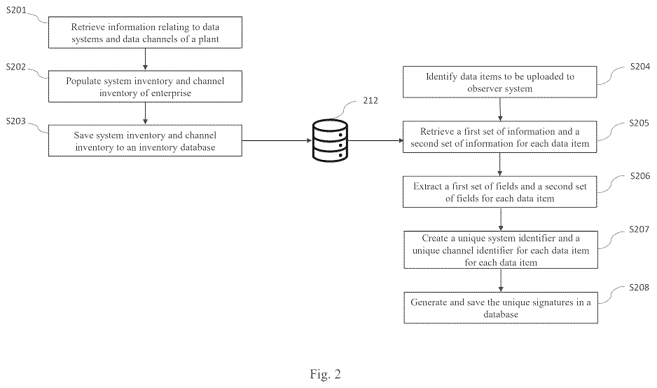

FIG. 2 illustrates steps executed by a method for generating unique signatures of data items of an enterprise, in accordance with an embodiment of the present invention. Step S201 involves retrieving information relating to data systems and data channels of an industrial plant of an enterprise from an authorized individual of the industrial plant. Step S202 involves populating a system inventory and a channel inventory based on the information provided by the authorized individual. The system inventory is used for storing information relating to data systems of industrial plants of the enterprise, and details or data relating to data systems of the industrial plant in the information provided by the authorized individual is stored in the system inventory. The channel inventory is used for storing information relating to data channels of industrial plants of the enterprise, and details or data relating to data channels of the industrial plant in the information provided by the authorized individual is stored in the channel inventory The fields of the system inventory and the channel inventory may be pre-determined based on the nature of operations of the enterprise.

The steps S201 and S202 are performed for all industrial plants of the enterprise. In one embodiment, the steps S201 and S202 may be performed simultaneously for every industrial plant of the enterprise. In other embodiments, the steps S201 and S202 may be performed iteratively for each industrial plant of the enterprise till information relating to all industrial plants are stored in the system inventory and channel inventory of the enterprise. Step S203 involves saving of the populated system inventory and channel inventory in an inventory database 212. The inventory database 212 may be located within the proposed system, or may be a cloud-based database which may be accessible by the data management systems of all industrial plants of the enterprise and an observer system of the enterprise.

Steps S201, S202, and S203 are performed prior to the generation of unique signatures by the proposed system. In most embodiments, the steps are performed only at one instance, during the setting up of the proposed system. In some embodiments, the steps S201 to S203 may be performed one or more times to save details relating to data systems and channels of one or more industrial plants established after the setting up of the proposed system. In other embodiments, the steps S201 to S203 may be performed one or more time for updating entries of system inventory and channel inventory based on request of a user provided to the inventory module.

Step S204 involves identifying data items for which unique signature is to be generated by the proposed system. The step is performed when one or more data items are to be uploaded to an observer system of the enterprise for handling or resolving an error or warning detected by the observer system. In order to retrieve the requisite data items, one or more queries indicating the requirements of the observer system with regard to data items to be uploaded may be provided to the proposed system. In another embodiment, a query may be provided by a cloud-based software or system for retrieving select data items of one or more plants. In another embodiment, one or more data items required for updating records of an enterprise may be queried to the proposed system. The identification of the one or more data items in the above-mentioned embodiments is performed based on processing of the query by the proposed system.

Step S205 involves retrieving a first set of information and a second set of information for each of the identified data items, hereafter referred to as source system information and associated data channel information respectively. The source system information is retrieved from the system inventory of the enterprise, and relates to a source data system of the data item. Similarly, the associated data channel information is retrieved from the channel inventory of the of the enterprise, and relates to an associated data channel of the data item. In an embodiment where separate system inventories and channel inventories are created for different data items, the source system information and the associated channel information for each data item is retrieved from the corresponding system inventory and channel inventory respectively.

Step S206 involves extracting specific fields for each data item, required for generating a unique signature of the data item. The specific fields extracted includes a first set of specific fields extracted from the source system information of the data item and a second set of specific fields extracted from the associated data channel information. The first set of specific fields includes at least a unique reference of a source data system of the data item, obtained from the source system information. Additionally, the first set of specific fields may also include other fields extracted from the source system information. Similarly, the second set of specific fields includes at least a unique reference of a source data system of a data item, a unique reference of a target data system of the data item, and a name of an associated channel of the data item, obtained from the associated data channel information of the data item. Additionally, the second set of specific fields may also include other fields extracted from the associated data channel information.

The other fields extracted from the source system information and the associated data channel information for the first set of specific fields and second set of specific fields may be based on rules relating to extraction of specific fields. The rules to be applied for extraction of specific fields relating to data items of an enterprise may be pre-defined by one or more individuals of the enterprise based on the types of parameters or details required in the unique signatures generated for data items of the enterprise. In some embodiment, the rules applicable for extraction may also vary based on the data item corresponding to which the specific fields are extracted.

Step S207 involves creating a unique system identifier and a unique channel identifier for each data item of the identified data items, where the unique system identifier is associated with a source data system of the data item and is created based on processing of a first set of specific fields associated with the data item, obtained at step S206. The processing of the first set of specific fields of the data item performed for creation of the unique system identifier involves collation of the specific fields. The collation is performed in a pre-defined format, where the format is defined by one or more individuals of the enterprise based on required characteristics of unique signature to be generated for the data item. In some embodiments, one or more fields of the first set of specific fields may be modified or further processed before collation. In some embodiments, one or more fields of the first set of specific fields may be combined prior to collation.

Similarly, the unique channel identifier is associated with an associated data channel of a data item, where the unique channel identifier is associated with an associated data channel of the data item and is created based on processing of a second set of specific fields associated with the data item, obtained at step S207. The processing of the second set of specific fields of the data item performed for creation of the unique system identifier involves collation of the specific fields. The collation is performed in a pre-defined format, where the format is defined by one or more individuals of the enterprise based on required characteristics of unique signature to be generated for the data item. In some embodiments, one or more fields of the second set of specific fields may be modified or further processed before collation. In some embodiments, one or more fields of the first set of specific fields may be combined prior to collation.

The unique system identifier and the unique channel identifier created for each data item may be combined for generating a unique signature of the data item at step S208. In an embodiment of the present invention, the combination of the unique system identifier and the unique channel identifier may be converted to a different format to generate the unique signature. In another embodiment, the combination of the unique system identifier and the unique channel identifier may be encrypted with a key to generate an encrypted unique signature to ensure security, where the key may be known to the systems of the enterprise authorized to retrieved the unique signature. The unique signature generated for each data item is thereafter stored in a signature database at step S208, where the signature database is accessible to the observer system. In certain embodiments of the present invention, the signature database may be hosted within the observer system of the enterprise. The steps S205 to S208 are performed for each data item identified at step S204. Further, multiple iterations of steps S204 to S208 may be performed corresponding to queries of an observer system for uploading of data items from one or more industrial plants of the enterprise. Hence, steps S204 to S208 are performed in real-time based on requirements of the observer system.

In an embodiment of the present invention, the observer system may first access the signature database to identify data items stored therein, and only raise a query of data items for which signatures are not already generated. In another embodiment, the observer system may periodically query the proposed system for re-generating the signatures of data items to ensure that updated versions of signatures of data items are stored in the signature database. Alternatively, the proposed system may be configured to automatically update signatures of data items stored in the signature database at regular intervals, or after an event such as resolution of a KPI deviation.

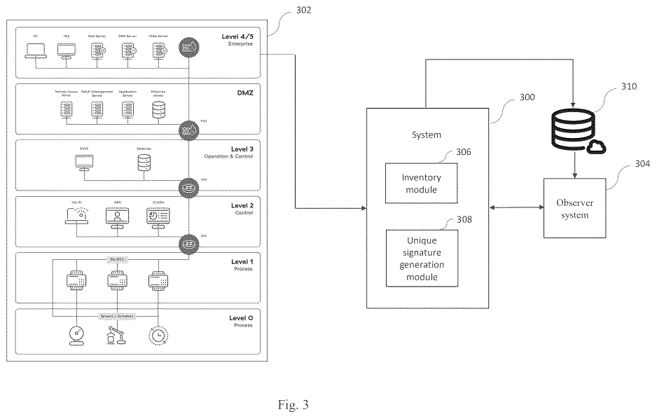

FIG. 3 illustrates configuration of the proposed system with respect to a data management system of an industrial plant of an enterprise and an observer system of the enterprise. A data management system of an industrial plant comprises one or more levels, where each level comprises one or more data systems and is used for performing a specific functionality essential to the overall functioning of the data management system. The data management system 302 illustrated in FIG. 3 comprises 5 levels, where a last level is used for internet-based communication with external systems for enterprise-level management of the industrial plant. An observer system 304 is one of the external systems that may be connected to the data management system 302 by means of the last level of data management system 302. In certain cases, the observer system 304 may be a cloud-based processing system connected with the industrial plant.

One or more data items created at different levels of the data management system 302 of the industrial plant may be uploaded by the observer system 304 for addressing or resolving an alert or error generated with respect to the operation of the industrial plant. The one or more data items are generally uploaded by the observer system 304 from the last level of data management system 302. In the present embodiment, the proposed system 300 acts as an intermediary mechanism between the last level of the data management system 302 and the observer system 304 for generating unique signatures for each data item to be uploaded to the observer system 304. The unique signatures are generated by a unique signature generation module 308 based on information relating to a source data system and an associated channel of each data item, where the information is retrieved from a system inventory and a channel inventory created by an inventory module 306 of the proposed system 300.

The inventory module 306 generates the system inventory containing information relating to all data systems of the industrial plant and the channel inventory containing information relating to all data channels of the industrial plant. The system inventory and the channel inventory are generated based on an input retrieved from one or more authorized individuals of the industrial plant having knowledge regarding the assets, data systems, and data channels of the industrial plant. The unique signatures generated by the proposed system 300 is saved to a signature database 310, which may thereafter be accessed by the observer system 304 for obtaining information or context relating to source of a data item uploaded by the observer system 304.

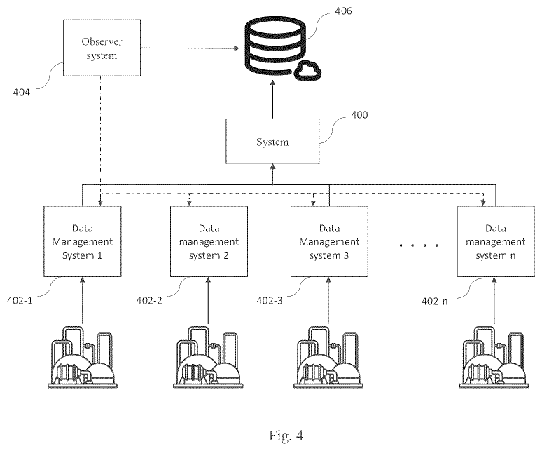

The above-mentioned configuration may also be implemented in embodiments where an observer system of an enterprise is required to manage and control operations of a plurality of industrial plants of an enterprise. FIG. 4 illustrates configuration of the proposed system with respect to a plurality of data management systems of industrial plants of an enterprise and an observer system of the enterprise. In such embodiments, the proposed system 400 acts as an intermediary mechanism between data management systems 402-1 to 402-n (collectively labelled 402) of industrial plants of the enterprise and the observer system 404, and is used for generating unique signatures for each data item prior to upload of the data items to the observer system 404.

Herein, each data management system 402 is used for managing operations of assets and data systems of an industrial plant, and a last level of each data management system 402 may be connected to the proposed system 400. The system 400 generates a system inventory and a channel inventory for storing relevant information relating to all data systems of each data management system 402 and all data channels of each data management system 402 respectively. The information to be stored as entries of the system inventory and the channel inventory corresponding to each data item is retrieved from one or more authorized individuals of the industrial plant in which the data item was created. In one embodiment, relevant parameters to be entered in the system inventory and channel inventory may be extracted from the information provided by the one or more authorized individuals. In certain embodiments, one or more systems inventories and data inventories are created, where each data management system 402 may have a dedicated system inventory and channel inventory.

The proposed system 400 generates unique signatures for one or more data items required by the signature system based on information stored in the system inventory and channel inventory. The one or more data items required to be uploaded from one or more data management systems 402 of industrial plants of the enterprise may be communication to the proposed system 400 as a query. The system 400 generates the unique signatures for the one or more data items based on processing of the query. Firstly, the system 400 identifies the one or more data items for which unique signatures are to be generated, based on processing of the query. Thereafter, the proposed system 400 retrieves a first set of information, hereafter referred to as source system information, and a second set of information, hereafter referred to as associated data channel information, corresponding to each identified data item.

The proposed system 400 generates a unique system identifier and a unique channel identifier for each data item based on the source system information and associated data channel information retrieved for the data item. The unique system identifier essentially acts as a unique identifier for the source data system of the data item, and the unique channel identifier essentially acts as a unique identifier for the associated data channel of the data item. The specific fields extracted from the source system information and the associated data channel information may depend on the characteristics of the unique signatures required by the enterprise, and may be defined by rules provided by one or more individuals of the enterprise.

A unique signature is generated for each identified data item by combining the unique system identifier and the unique channel identifier of the data item. The combination herein may include a simple collation of the unique system identifier and unique channel identifier, or collation after processing of the unique system identifier and the unique channel identifier. The unique signatures generated by the proposed system 400 is stored in a signature database 406. The signature database 406 may be accessed by an observer system 404 during resolution of errors for retrieving a unique signature of a data item, and the unique signature may be used by the observer system 404 for obtaining information regarding the source data system of the data item.

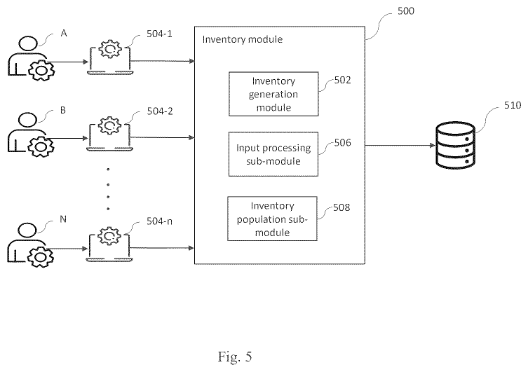

FIG. 5 illustrates an inventory module for populating a system inventory and a channel inventory of an enterprise corresponding to inputs provided for multiple industrial plants, in accordance with an embodiment of the present invention. The inventory module 500 may be used for generating a populated system inventory and channel inventory of an enterprise, where the system inventory and channel inventory are populated with information relating to all data systems and all data channels of industrial plants of the enterprise. At the outset, an empty system inventory and an empty channel inventory may be created by an inventory generation sub-module 502 of the inventory module 500, prior to population of the inventories based on inputs relating to data systems and data channels of industrial plants of the enterprise.

The inventory generation sub-module 502 creates the empty system inventory and the empty channel inventory based on pre-determined template provided by an authorized individual of the enterprise, where the template may be based on different parameters of the data systems and data channels required by an observer system of the enterprise. An example of fields of an empty system inventory and an empty channel inventory for storing parameters of a data item is cited in Table 3 and Table 4 respectively.

TABLE 3

| | | |
|---|---|---|
| # | Details | Parameters |

| | |
|---|---|
| 1 | Plant name |
| 2 | Location identifier |
| 3 | System name |
| 4 | Unique reference |

TABLE 4

| | |
|---|---|
| Details | Parameter |

Channel Name
Source System Unique
Reference
Source System Type
Target System Unique
Reference
Target System Type

In some embodiments, the system inventory and channel inventory may include fields providing details or description of the parameters stored therein, as depicted in Table 3 and Table 4. In other embodiments, the system and channel inventory may merely comprise a listing of all details of the source system and the associated data channel, where the order of listing may be pre-defined by an individual of the enterprise. In some embodiments, separate system inventories and channel inventories may be created for different industrial plants of the enterprise, and the templates of the system inventories and the channel inventories may be provided by an individual of the enterprise. Alternatively, a template for a system inventory and a channel inventory of an industrial plant may be provided by an authorized individual of the industrial plant having knowledge regarding data systems and data channels of the industrial plant.

Information relating to data systems and data channels of each industrial plant is provided by an authorized individual of the industrial plant. The information is provided by an authorized individual of an industrial plant by means of an input device 504. For an enterprise having multiple industrial plants, information relating to each industrial plant may be provided means of a dedicated input device. FIG. 5 illustrates a plurality of input devices 504-1 to 504-n (collectively labelled 504) used for providing information relating to data systems and data channels of n industrial plants of the enterprise. The information provided by means of each input device 504 is processed by an input processing sub-module 506 to obtain parameters to be filled into the system inventory and channel inventory. In some cases, extensive data relating to all aspects of a data management system of an industrial plant may be provided by an authorized individual of the industrial plant. In such scenarios, only data or parameters relevant with respect to fields of system inventory and channel inventory are extracted by the input processing sub-module 506 after processing of the information retrieved.

The inventory population sub-module 508 thereafter uses the parameters extracted by the input processing sub-module for each data item, and populates the fields of the system inventory and channel inventory with the parameters. Table. 5 and Table. 6 illustrate populated fields of the exemplary system inventory and channel inventory.

TABLE 5

| # | Details | Parameters |
|---|---|---|
| 1 | Plant name | xyz_corporation |
| 2 | Location identifier | Bangalore |
| 3 | System name | XnR |
| 4 | Unique reference | XnR_BLR02_CDU1 |

TABLE 6

| Details | Parameter |
|---|---|
| Channel Name | Malibu |
| Channel Description | ACM connection to Experion R500 |
| Location Identifier | Bangalore |
| Source System Unique | XnR_BLR02_CDU1 |
| Reference | |
| Source System Type | Control System |
| Source System | Refinery Experion System |
| Description | |
| Source Network Level | L2 |
| Target System Unique | L3ACM1 |
| Reference | |
| Target System Type | Alarm System |
| Target System Description | ACM Master Alarm System |
| Target Network Level | L3 |

The system inventory and the channel inventory are stored such that the unique reference of the source data system and the target data system stored therein matches or is the same as the unique reference stored in entries of the system inventory corresponding to the source data system and the target data system. In the exemplary embodiment cited above with respect to Table. 5 and Table. 6, it can be observed that the unique reference of the source data system in the channel inventory matches the unique reference of the data system in the system inventory. The system inventory is populated with the parameters in such a manner that a set of parameters relating to a data system of an industrial plant are stored together, and sets of parameters relating to all data system of the industrial plant are stored one after the other. Similarly, the channel inventory is populated in such a manner that a set of parameters relating to a data channel of an industrial plant are stored together, and sets of parameters relating to all data channels of the industrial plant are stored one after the other.

The system inventory and the channel inventory are populated in such a manner for all industrial plants of the enterprise. On completion of such population, the populated system inventory and the channel inventory are saved to an inventory database 510. In embodiments involving separate system inventories and channel inventories created for each industrial plant of an enterprise, the inventory population sub-module 508 may populate a system inventory and a channel inventory of each industrial plant based on parameters obtained by processing of information provided by an authorized individual of the industrial plant. In such embodiments, the inventory database may be used to save one or more populated system inventories and channel inventories corresponding to the plurality of industrial plants of the enterprise. The inventory database 510 may be accessed by an observer system of an industrial plant for retrieving additional information regarding data systems and data channels of different industrial plants of the enterprise.

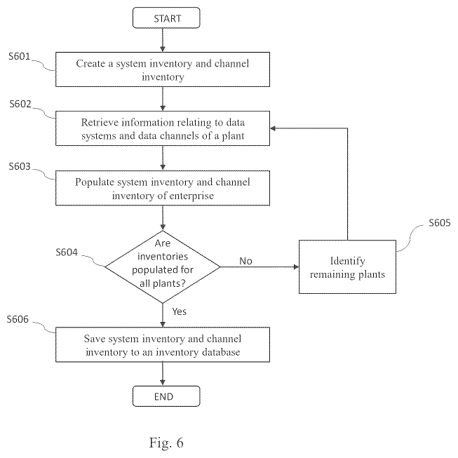

FIG. 6 illustrates steps executed by an inventory module for populating a system inventory and a channel inventory of an enterprise, in accordance with an embodiment of the present invention. Steps S601 involves the creation of a system inventory and a channel inventory. The system inventory and the channel inventory may be created at step S601 in a format or manner defined by one or more individuals of the enterprise, wherein the format may define the parameters relating to data systems and data channels of the enterprise that are to be included in the inventory. In certain embodiments, the system inventory and channel inventory are created at step S601 based on pre-determined templates provided by an authorized individual of the enterprise. The inventories created at step S601 based on such templates comprise empty fields to be populated with parameters obtained based on information provided by authorized individuals of industrial plants of the enterprise.

At step S602, information relating to data systems and data channels of each industrial plant of the enterprise is retrieved from an authorized individual of the industrial plant. The information provided by an authorized individual of an industrial plant may be specific information relating to data systems and data channels of the industrial plant, or may be extensive information relating to different aspects of the data management system of an industrial plant including the data systems and data channels. Such information may be processed by the inventory module for retrieving parameters relevant for populating the system inventory and the channel inventory of the enterprise. In some embodiments, processing of the information provided by an authorized individual of an industrial plant may also involve conversion of the information into a type from which relevant parameters may be extracted.

At step S603, the system inventory is populated with relevant parameters corresponding to each data system of every industrial plant of the enterprise, where the relevant parameters are obtained as an outcome of step S602. Similarly, the channel inventory is populated with relevant parameters corresponding to each data channel of every industrial plant of the enterprise, where the relevant parameters are obtained as an outcome of step S602. In certain embodiments, separate system inventories and channel inventories may be generated for different industrial plants of an enterprise at step S601, and step S602 may involve the retrieval of information only relating to data systems and data channels of one industrial plant. Step S603 in such embodiments involves the population of system inventory and channel inventory of each plant based on information retrieved at step S603.

At step S604, the inventory module identifies whether there are any industrial plants remaining corresponding to which system inventory and channel inventory are populated. If yes, the remaining industrial plants are identified at step S605 and steps S602 and S603 are performed for the remaining industrial plants of the enterprise. If no industrial plants remain, the system inventory and the channel inventory may be stored to an inventory database at step S606. In some embodiments of the present invention, the inventory database is a cloud-based database, and ensures that the details relating to data systems and data channels of all industrial plants of an enterprise are accessible to an observer system of the enterprise and the one or more data management systems of the industrial plants of the enterprise.

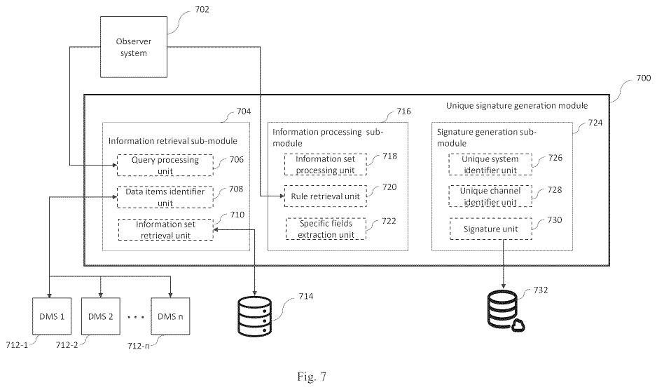

FIG. 7 illustrates a unique signature generation module for generating unique signatures of data items based on information stored in an inventory database, in accordance with an embodiment of the present invention. The unique signature generation module 700 is used for generating unique signature for data items to be uploaded by an observer system 702 of an enterprise, where the data items are used by the observer system 702 for resolving an error or alert with respect to operation of one or more industrial plants of the enterprise. The unique signatures are generated by the unique signature generation module 700 to avoid name collision of data items from the same or different industrial plants of the enterprise, and to enable identification of source data system and associated data channel of each data item.

An information retrieval sub-module 704 of the unique signature generation module 700 is used for retrieving information from the inventory database for data items to be uploaded to the observer system 702. The retrieval of such information is achieved based on a query processing unit 706, a data items identifier unit 708, and an information set retrieval unit 710 of the information retrieval sub-module 704. The query processing unit 706 is used for processing a query raised by the observer system 702, wherein the query raised relates to the data items to be ingested by the observer system for resolution of an error. Such a query is processed by the query processing unit 706 to obtain context as to the data items required by the observer system 702. For example, a query of the observer system 702 may indicate deviation of KPIs associated with chemical processes in one or more industrial plants of an enterprise. In such an instance, such a query may be processed by the query processing unit 706 to identify that parameters associated with chemical processes are to be retrieved.

A context of a query shared by an observer system 702, obtained by the query processing unit 706, may be used by the data items identifier unit 708 for identifying data items of one or more industrial plants of the enterprise associated with the context of the query. With regard to the above-mentioned example, the data items identifier unit 708 identifies data items associated with chemical processes of the industrial plants of the enterprise. The data items may include assets, limits, and tags of different parameters detected by sensor devices of the industrial plants. The data items may be identified from one or more data management systems 712-1 to 712-n of the enterprise, where each data management system is associated with an industrial plant of the enterprise.

The information set retrieval unit 710 is used to retrieve a first set of information relating to a source data system, hereafter referred to as source system information and a second set of information relating to an associated data channel, hereafter referred to as associated data channel information, of each data item identified by the data items identifier unit 708. The source system information and the associated data channel information are retrieved from a system inventory and a channel inventory respectively, where the system inventory and the channel inventory are stored in an inventory database 714. That is, for each identified data item, a source system information is retrieved from entries of the system inventory associated with the data item, and an associated data channel information is retrieved from entries of the channel inventory associated with the data item.

The source system information and the associated data channel information for each data item is processed by the information processing sub-module 716 to extract a first set of specific fields relating to source data system and a second set of specific fields relating to associated data system of each data item respectively. The extraction of the first set of specific fields and the second set of specific fields is performed using an information set processing unit 718, a rule retrieval unit 720, and a specific fields extraction unit 722. The information set processing unit 718 is used to perform requisite processing operations of the source system information and the associated data channel information of data items obtained from the information retrieval sub-module 704, where the processing may include conversion of the source system information and the associated data channel information into a format suitable for extraction of specific fields, removal of erroneous data within the source system information and the associated data channel information etc.

The processed source system information and associated data channel information may be thereafter used for extraction of a first set of specific fields and a second set of specific fields respectively. However, the extraction of the specific fields may be based on one or more rule relating to the nature and/or content of the specific fields to be extracted. Such rules may depend on the data items for which the fields are being extracted, or based on the operations performed by the industrial plants from which the data items are generated. Such rules may be defined by an individual of the enterprise, and may be stored in a repository or database of the observer system of the enterprise. The rule retrieval unit 720 is used for retrieving relevant rules relating to extraction of a first set of specific fields and a second set of specific fields. In some embodiments, a rule relating to extraction of specific fields may indicate the fields to be extracted from the source system information and the associated data channel information. In another embodiment, a rule relating to extraction of specific fields may indicate processing that may be required with respect to one or more fields to be extracted. In another embodiment, a rule relating to extraction of specific fields may indicate parameters or data in the source system information and the associated data channel information that are not to be extracted as specific fields.

The rules retrieved by the rule retrieval unit 720 may be used by the specific fields extraction unit 722 for extracting a first set of specific fields from the source system information obtained after processing by the information set processing unit 718. The first set of specific fields of each data item is associated with a source data system of the data item. One field of the first set of specific fields is a unique reference of the source data system. Similarly, the retrieved rules are also used by the specific fields extraction unit 722 for extracting a second set of specific fields from the associated data channel information obtained after processing by the information set processing unit 718. The second set of specific fields of each data item is associated with an associated data channel of the data item. The second set of specific fields mandatorily comprises a unique reference of the source data system, a unique reference of the target data system, and a name of the associated data channel of the data item.

The first set of specific fields and the second set of specific fields extracted by the information processing sub-module for each data item is used by the signature generation sub-module 724 for generating a unique signature of each data item. The unique signature is generated based on a unique system identifier unit 726, a unique channel identifier unit 728, and a signature unit 730 of the signature generation sub-module 724. The unique system identifier unit 726 is used for creating a unique system identifier for each data item, where the unique system identifier is created by combining the first set of specific fields. The unique system identifier may be created by simply collating the first set of specific fields. In some embodiments, the unique system identifier is created by performing one or more processing operations on the first set of specific fields prior to collating of the fields.

The unique channel identifier unit 728 is used for creating a unique channel identifier for each data item, where the unique channel identifier is created by combining the second set of specific fields. The unique channel identifier may be created by simply collating the second set of specific fields. In some embodiments, the unique channel identifier is created by performing one or more processing operations on the second set of specific fields prior to collating of the fields. The unique system identifier and the unique channel identifier created for each data item are combined by the signature unit 730 to generate the unique signature of the data item. The unique signatures created in such a manner for all the data items to be uploaded to the observer system 702 is saved by the signature unit 730 to a signature database 732. After generation of the unique signatures, the data items may be uploaded by the observer system 702. The unique signatures of the data items may be accessed by the observer system 702 for identifying the source data system of each data item.

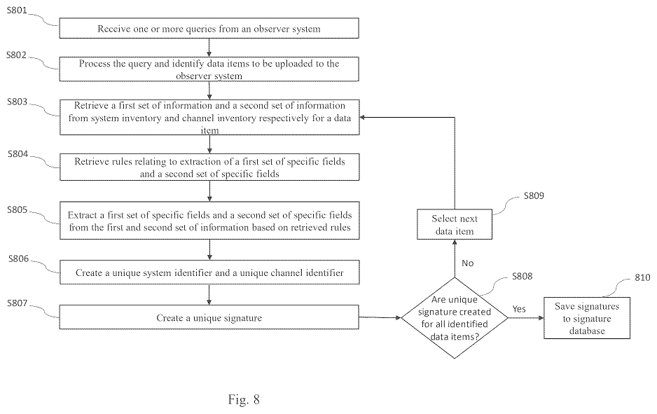

FIG. 8 illustrates steps executed by a unique signature generation module for generating unique signatures for data items of an enterprise to be uploaded to an observer system, in accordance with an embodiment of the present invention. Step S801 involves receiving a query from the observer system of the enterprise, where the query is provided by the observer system for retrieving one or more data items. The one or more data items may be required by the observer system for resolving an error or warning detected in, or with respect to, one or more industrial plants of the enterprise. The query may either explicitly mention the data items to be uploaded, or may be provided as a description of the nature and/or type of data items to be uploaded. In certain embodiments, one or more queries may be provided by the observer system for retrieving data items.

Step S802 involves processing the one or more queries received at step S801. The query is processed to identify the one or more data items for which unique signatures are to be generated. The one or more data items identified at step S802 may belong to one or more industrial plants of the enterprise. At step S803, corresponding to a data item of the one or more data items identified, a first set of information and a second set of information is retrieved from a system inventory and a channel inventory of the enterprise respectively. The first set of information, hereafter referred to as source system information, retrieved for a data item from the system inventory relates to a source system of the data item. The second set of information, hereafter referred to as associated data channel information, retrieved for the data item from the channel inventory relates to a target data system of the data item.

Step S804 involves retrieving one or more rules relating to extraction of specific fields from the source system information and the associated data channel information relating to the data item. The one or more rules relating to specific fields may be defined by one or more individuals of the enterprise for ensuring that required fields are extracted from the source system information and the associated data channel information. In an embodiment, the rules for extraction of fields may vary based on nature or type of data item for which specific fields are to be extracted.

Step S805 involves extracting a first set of specific fields from the source system information and a second set of specific fields from the associated data channel information of the data item based on rules retrieved at step S804. The first set of specific fields extracted from the source system information are indicative of various parameters associated with a source data system of the data item, and the first set of specific fields include a unique reference of the source data system. The second set of specific fields extracted from the associated data channel information are indicative of various parameters associated with an associated data channel of the data item, and the second set of specific fields include a unique reference of the source data system of the data item, a unique reference of a target data of the data item, and a channel name of the associated data channel.

Step S806 involves creating a unique system identifier and a unique channel identifier for a data item based on the first set of specific fields and second set of specific fields extracted at step S805 corresponding to the data item. The unique system identifier of the data item is created by combining the fields of the first set of specific fields, and is essentially a unique identifier of the source data system of the data item. In an embodiment of the present invention, combining of the fields of the first set of specific fields involve collating the fields. In another embodiment, one or more fields of the first set of fields may be processed before the combining of fields.

The unique channel identifier of the data item is created at step S806 by combining the fields of the second set of specific fields, and is essentially a unique identifier of the associated data channel of the data item. In an embodiment of the present invention, combining of the fields of the second set of specific fields involve collating the fields. In another embodiment, one or more fields of the first set of fields may be processed before the combining of fields.

The unique system identifier and the unique system identifier of a data item is combined at step S807 for generating a unique signature of the data item. Hence, the unique signature generated for each data item of the set of data item identified for upload to the observer system comprises a unique system identifier and a unique system identifier, where the unique system identifier and the unique system identifier may be used by the observer system for identifying and obtaining context regarding source of the data item. After a unique signature is generated for a data item, an identification of remaining data items for which unique signatures are to be generated is performed at step S808. If data items remain, a next data item is selected at step S809, and steps S803 to S807 are performed for the next data item from the remaining data items. If no data items remain, the unique signatures generated for the data items are saved to a signature database at step S810. The signature database may be a cloud-based database accessible by the observer system. In an embodiment, the signature database may be maintained within the observer system. After the generation of unique signatures of data items, the data items may be uploaded by the observer system for processing, and context regarding source of each data item may be obtained by the observer system by accessing a unique signature of the data item from the signature database.

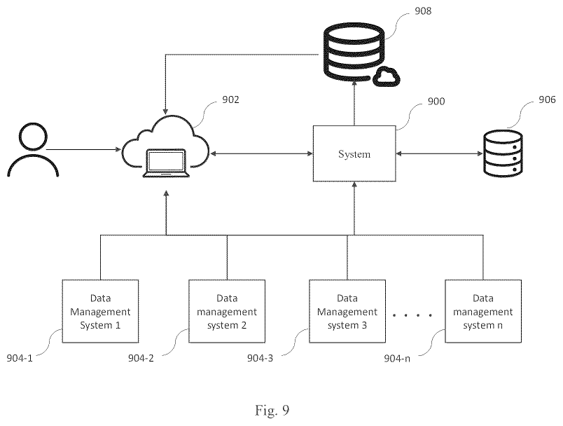

In some embodiments of the present invention, the system may be used for generating unique signatures of data items of an enterprise in response to queries or instructions provided by a user. The user may be an authorized individual of the enterprise, tasked with resolving errors or complaints, where the errors or complaints may be raised by one or more data management systems of industrial plants of the enterprise, may be detected due to a KPI deviation, or may be provided by an individual responsible for identifying drawbacks in operations of the enterprise. FIG. 9 illustrates an implementation of the proposed system for generating unique signatures of data items based on queries raised by an individual of an enterprise, in accordance with an embodiment of the present invention. Herein, the queries or instructions may be provided by the user to a processing device 902, where the processing device 902 is used for identifying corrective actions for the error or complaints.

The queries or instructions provided by the user may be processed by the processing device 902, and the processing device 902 may retrieve one or more data items from one or more data management systems 904-1 to 904-n (collectively labelled 903) required for determining corrective actions to be taken for resolving errors. Prior to retrieving the one or more data items, an instruction is provided by the processing device 902 to the proposed system 900 for generating unique signatures of the data items. Based on the instruction provided by the processing device 902, the proposed system 900 retrieves a first set of information relating to a source data system of each data item from a system inventory saved in an inventory database 906. The proposed system 900 also retrieves a second set of information relating to an associated data channel of each data item from a channel inventory saved in the inventory database 906. In such an embodiment, the system inventory and the channel inventory stored in the inventory database 906 is created by the proposed system 900 prior to receipt of the instruction from the processing device 902.

The first set of information and second set of information corresponding to a source data system and an associated data channel for each data item is thereafter used by the proposed system 900 for creating a unique system identifier for the source data system and a unique channel identifier for the associated data channel. The unique system identifier and the unique channel identifier created for each data item constitutes the unique signature of the data item. A set of unique signatures generated by the proposed system 900 corresponding to data items required by the processing device 902 may be saved by the proposed system 900 in a signature database 908, which may be accessed by the processing device 902. In an embodiment, the unique signatures of the data items may be provided by the proposed system 900 directly to the processing device 902.

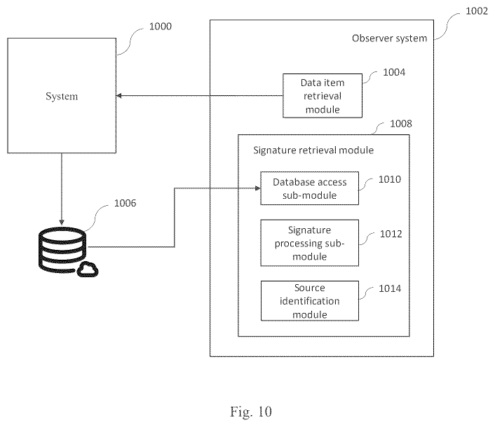

In an embodiment of the present invention, an observer system or an authorized cloud-based system of an enterprise may have mechanisms for accessing and processing unique signatures generated by the proposed system for one or more data items of the enterprise. FIG. 10 illustrates an observer system having modules for retrieval and processing of unique signature of data items of an enterprise, in accordance with an embodiment of the present invention. In such an embodiment, the proposed system 1000 generates unique signatures for one or more data items based on a request or a query shared by a data item retrieval module 1004 of the observer system 1002. The request or query provided by the data item retrieval module 1004 may be a list of data items which are to be retrieved or for which unique signatures are to be generated by the proposed system 1000. In an embodiment, the query may be a detailed instruction relating to the type or characteristics of data items to be retrieved.

The proposed system 1000 processes the query or request provided by the data item retrieval module 1004 for identifying the data items for which unique signatures are to be generated. Thereafter, the proposed system 1000 retrieves for each identified data item, a source system information and an associated data channel information from a system inventory and a channel inventory of the enterprise. The system inventory and the channel inventory comprise information relating to all data systems and data channels of plants of the enterprise, and is generated prior to receipt of the query of request from the data item retrieval module 1004. The source system information and the associated data channel information for each data item is used for generating a unique system identifier and a unique channel identifier for the data item, where the unique system identifier relates to a source data system of the data item and the unique channel identifier to an associated data channel of the data item. A unique signature is generated for each data item by combining the unique system identifier and the unique channel identifier of the data item.

The unique signatures generated for the identified data items may be stored in a signature database 1006. A database access sub-module 1010 of a signature retrieval module 1008 is used by the observer system 1002 for retrieving unique signatures stored in the signature database 1006. In other embodiments, the unique signatures may be directly provided to the observer system 1002 by the proposed system 1000 in response to the query provided. The unique signatures retrieved by the database access sub-module 1010 may be used by a signature processing sub-module 1012 of the signature retrieval module 1008 for processing of the unique signatures. The processing of unique signatures may include converting the unique signatures into a format that can be used by the observer system 1002 for determining sources of the data items. In embodiments where the unique signatures were encrypted during generation by the proposed system 1000, the processing performed by the signature processing sub-module 1012 may also include decryption of the unique password based on a key. The key may be known to the observer system 1002, or may be retrieved from the proposed system 1000 by the observer system.

The signature processing sub-module 1012 thereafter further processes the unique signatures for identifying sources of the data items. The identification of the source data systems and the other details relating to the source of the data items may be based on the unique source identifiers and unique channel identifiers retrieved from the unique signatures of the data items. Specifically, a unique reference of a source data system of each data item, obtained from the unique system identifier of the data item, may be used for retrieving additional information of the source data system. Similarly, a unique reference of an associated data channel of each data item, obtained from the unique channel identifier of the data item, may be used for retrieving additional information relating to a lineage of the data item. In certain embodiments, information relating to the data items may be retrieved by accessing the entries in the system inventory and the channel inventory of the enterprise corresponding to the unique reference of the source system and the associated channel of the data item.

The unique signatures retrieved from the signature database 1006 and information retrieved by the observer system from the unique signatures may be used for training a data model in the cloud environment, wherein the trained data model may be used for automated management of industrial plants of an enterprise at an enterprise level. The data model trained on such data may be more accurate in capturing the patterns and operations of different industrial plants of the enterprise, and the data model may be able to provide functional hints to individuals at the industrial plant level based on insights obtained due to training on data obtained from different industrial plants of the enterprise.

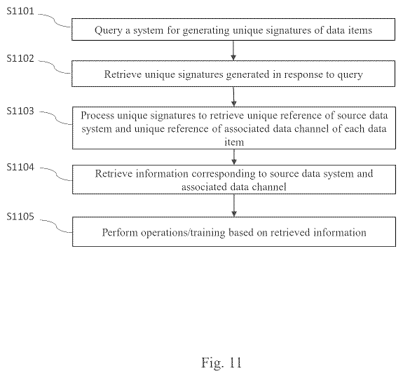

FIG. 11 illustrates steps executed by an observer system for retrieval and processing of unique signature of data items of an enterprise, in accordance with an embodiment of the present invention. Step S1101 involves generation of unique signatures by the proposed system, where the generation of unique signatures is trigger by a query or instruction provided to the proposed system by the observer system. The query may be indicative of the data items for which unique signatures are to be generated, or data items required by the observer system for performing an operation. The system generates unique signatures for the required data items, based on processing of the query to identify the data items for which unique signatures are to be generated.

Step S1102 involves retrieving unique signatures generated by the proposed system for the required data items from a signature database. The signature database may be a cloud-based database used by the proposed system for storing unique signatures of data items. In certain embodiments, the unique signatures may be retrieved by the observer system directly from the proposed system. The observer system may thereafter process each unique signature of the retrieved unique signatures to extract a unique system identifier and a unique channel identifier of the data system. The processing performed by the observer system first involves conversion of a unique signature into a format suitable for extraction of the unique system identifier and the unique channel identifier. In embodiments where the unique signatures are encrypted during generation by the proposed system, processing of the unique signature by the observer system may also involve decryption of the unique signature.

The unique system identifier and the unique channel identifier of the data system are extracted from the processed unique signature for each data item. A unique reference of a source data system of the data item and a unique reference of an associated data channel of the data item is obtained from the unique system identifier and unique channel identifier by the observer system. Step S1103 involves retrieving information associated with each data item, where the information retrieved relates to the source data system and the associated data channel of the data item. Such information is retrieved by the observer system based on the unique reference of the source data system and the unique reference of the associated data channel. The unique references are used by the observer system for accessing corresponding entries in a system inventory and channel inventory of the enterprise, where the system inventory and channel inventory are generated by the proposed system for storing information related to data systems and data channels of the enterprise.

At step S1105, the information retrieved corresponding to each data item from the system inventory and the channel inventory may be used by the observer system for performing different operations relating to management of operations of different industrial plants of the enterprise. The information retrieved, along with the unique signatures generated by the proposed system, may be used by the observer system for training a data model. The trained data model may be used for automated management of operations at an enterprise level, and may also be used for providing insights relating to improvement of operations of one or more industrial plants, or the enterprise as a whole.

An embodiment of the invention may be an article of manufacture in which a machine-readable medium (such as microelectronic memory) has stored thereon instructions which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components. Also, although the discussion focuses on uplink medium control with respect to frame aggregation, it is contemplated that control of other types of messages are applicable.

In the above description, for purposes of explanation, numerous specific details are set forth in order to provide a thorough understanding of the present systems and methods. It will be apparent the systems and methods may be practiced without these specific details. Reference in the specification to “an example” or similar language means that a particular feature, structure, or characteristic described in connection with that example is included as described, but may not be included in other examples.

An interface may be used to provide input or fetch output from the system. The interface may be implemented as a Command Line Interface (CLI), Graphical User Interface (GUI). Further, Application Programming Interfaces (APIs) may also be used for remotely interacting with edge systems and cloud servers.

A processor may include one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor), MIPS/ARM-class processor, a microprocessor, a digital signal processor, an application specific integrated circuit, a microcontroller, a state machine, or any type of programmable logic array.

A memory may include, but is no limited to, non-transitory machine-readable storage devices such as hard drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set as claimed in claims that issue from this application, in the specific form in which such claims issue, including any subsequent correction.

We claim:

1. A method for generating a unique signature of a data item of an enterprise, the method comprising:
identifying for the data item, a source data system, a target data system, and an associated data channel, wherein the source data system and the target data system belong to a plurality of data systems of the enterprise, and the associated data channel belongs to a plurality of data channels of the enterprise;
accessing a system inventory of the enterprise, wherein the system inventory comprises details of each data system of the plurality of data systems of the enterprise;
retrieving a first set of information from the system inventory, wherein the first set of information comprises a unique reference of the source data system;
accessing a channel inventory of the enterprise, wherein the channel inventory comprises details of each data channel of the plurality of data channels of the enterprise, and wherein the channel inventory has references to the plurality of data systems of the enterprise;
retrieving a second set of information from the channel inventory, wherein the second set of information comprises a channel name, the unique reference of the source data system, and a unique reference of the target data system;
generating the unique signature of the data item based on processing of the first set of information and the second set of information; and
storing the unique signature of the data item in a database.

2. The method of claim 1, further comprising:
accessing the unique signature of the data item from the database for retrieving details of the source data system and details of the associated data channel of the data item.

3. The method of claim 1, further comprising:
onboarding the data item of the enterprise on to a cloud network, wherein the cloud network processes a plurality of data items of the enterprise for providing insights relating to operation of the enterprise.

4. The method of claim 1, further comprising:
updating the system inventory and the channel inventory based on a user instruction.

5. The method of claim 1, wherein the first set of information further comprises a record identifier and a type of the data item, and the type of the data item include any one of a tag, an asset, or a limit.

6. The method of claim 1, wherein the second set of information further comprises: a location identifier of the associated data channel, a type of the source data system, and a type of the target data system.

7. The method of claim 1, wherein the details of each data system stored in the system inventory comprises a unique reference of the data system, a name of an entity of the enterprise to which the data system belongs, a location of the entity, and a name of the data system.

8. The method of claim 1, wherein the details of each data channel stored in the channel inventory comprises a unique reference of a first data system of the data channel, a name of the data channel, a description of the data channel, a location of the data channel, a type of the first data system of the data channel, a description of the first data system of the data channel, a level of the first data system of the data channel, a unique reference of a second data system of the data channel, a type of the second data system of the data channel, a description of the second data system of the data channel, and a level of the second data system of the data channel.

9. The method of claim 1, wherein the system inventory and the channel inventory are created before generation of the unique signature of a data item, based on instructions provided by an authorized user of the enterprise.

10. The method of claim 1, wherein lineage of the data item is tracked based on the unique signature of the data item.

11. A system for generating a unique signature of a data item of an enterprise, the system comprising:
a processor; and
a memory coupled with the processor, wherein the memory stores program instructions configured to:
identify for the data item, a source data system, a target data system, and an associated data channel, wherein the source data system and the target data system belong to a plurality of data systems of the enterprise, and the associated data channel belongs to a plurality of data channels of the enterprise;
access a system inventory of the enterprise, wherein the system inventory comprises details of each data system of the plurality of data systems of the enterprise;
retrieve a first set of information from the system inventory, wherein the first set of information comprises a unique reference of the source data system;
access a channel inventory of the enterprise, wherein the channel inventory comprises details of each data channel of the plurality of data channels of the enterprise, and wherein the channel inventory has references to the plurality of data systems of the enterprise;
retrieve a second set of information from the channel inventory, wherein the second set of information comprises a channel name, the unique reference of the source data system, and a unique reference of the target data system;
generate the unique signature of the data item based on processing of the first set of information and the second set of information; and
store the unique signature of the data item in a database.

12. The system of claim 11, wherein the program instructions are further configured to:
access the unique signature of the data item from the database for retrieving details of the source data system and details of the associated data channel of the data item.

13. The system of claim 11, wherein the program instructions are further configured to:
onboard the data item of the enterprise on to a cloud network, wherein the cloud network processes a plurality of data items of the enterprise for providing insights relating to operation of the enterprise.

14. The system of claim 11, wherein the program instructions are further configured to:
update the system inventory and the channel inventory based on a user instruction.

15. The system of claim 11, wherein the first set of information further comprises a record identifier and a type of the data item, and the type of the data item include any one of a tag, an asset, or a limit.

16. The system of claim 11, wherein the second set of information further comprises: a location identifier of the associated data channel, a type of the source data system, and a type of the target data system.

17. The system of claim 11, wherein the details of each data system stored in the system inventory comprises a unique reference of the data system, a name of an entity of the enterprise to which the data system belongs, a location of the entity, and a name of the data system.

18. The system of claim 11, wherein the details of each data channel stored in the channel inventory comprises a unique reference of a first data system of the data channel, a name of the data channel, a description of the data channel, a location of the data channel, a type of the first data system of the data channel, a description of the first data system of the data channel, a level of the first data system of the data channel, a unique reference of a second data system of the data channel, a type of the second data system of the data channel, a description of the second data system of the data channel, and a level of the second data system of the data channel.

19. The system of claim 11, wherein the system inventory and the channel inventory are created before generation of the unique signature of a data item, based on instructions provided by an authorized user of the enterprise.

20. A non-transitory computer-readable storage medium comprising computer program code for execution by one or more processors of an apparatus, the computer program code configured to, when executed by the one or more processors, cause the apparatus to:
identify for a data item of an enterprise, a source data system, a target data system, and an associated data channel, wherein the source data system and the target data system belong to a plurality of data systems of the enterprise, and the associated data channel belongs to a plurality of data channels of the enterprise;
access a system inventory of the enterprise, wherein the system inventory comprises details of each data system of the plurality of data systems of the enterprise;
retrieve a first set of information from the system inventory, wherein the first set of information comprises a unique reference of the source data system;
access a channel inventory of the enterprise, wherein the channel inventory comprises details of each data channel of the plurality of data channels of the enterprise, and wherein the channel inventory has references to the plurality of data systems of the enterprise;
retrieve a second set of information from the channel inventory, wherein the second set of information comprises a channel name, the unique reference of the source data system, and a unique reference of the target data system;
generate a unique signature of the data item based on processing of the first set of information and the second set of information; and
store the unique signature of the data item in a database.
